(19) United States
(12) Patent Application Publication
(10) Pub. No.: US 2024/0303067 A1
(43) Pub. Date: Sep. 12, 2024

(54) NETWORK DEVICE

(71) Applicant: PEGATRON CORPORATION, TAIPEI CITY (TW)

(72) Inventors: Chih-Hao Wang, Taipei City (TW); Chieh-Hsiang Tang, Taipei City (TW)

(73) Assignee: PEGATRON CORPORATION, TAIPEI CITY (TW)

(21) Appl. No.: 18/538,863

(22) Filed: Dec. 13, 2023

(30) Foreign Application Priority Data
Mar. 10, 2023 (TW) 112202134

(51) Int. Cl. G06F 8/65; G06F 8/71

(52) U.S. Cl. CPC G06F 8/65; G06F 8/71

(57) ABSTRACT

Disclosed is a network device, including a communication circuit and a processor. The processor is coupled to the communication circuit and configured to: in response to determining that a version of a first update file from an update server satisfies a preset condition, control the communication circuit to obtain the first update file from the update server; read identification information from at least one predetermined data location of the first update file; in response to determining that the identification information in the first update file matches the network device, update the network device based on the first update file.

### CROSS-REFERENCE TO RELATED APPLICATION

This application claims the priority benefit of Taiwan application serial no. 112202134, filed on Mar. 10, 2023. The entirety of the above-mentioned patent application is hereby incorporated by reference herein and made a part of this specification.

### BACKGROUND

### Technical Field

The invention relates to a network device, and particularly relates to a network device adapted to automatically perform update.

### Description of Related Art

In the existing technology, when an Internet of Things (IoT) device performs firmware update, it will first be determined whether a version of a firmware update file (for example, a BIN file) on an update server is newer than a current firmware version of the IoT device. If so, the IoT device may download the firmware update file accordingly and update the firmware of the IoT device accordingly.

However, since the IoT device does not confirm whether the firmware update file actually matches itself, the above update process may cause the IoT device to misuse firmware update files of other IoT devices for updating.

For example, when relevant maintenance personnel upload a firmware update file F corresponding to an Internet of Things device A of a certain machine type (such as a thermometer) to the update server, an Internet of Things device B belonging to another machine type (such as a gas meter) may probably download the firmware update file F from the update server just because it determines that a version of the firmware update file F is newer than a current firmware version of the IoT device B, and update the firmware of the IoT device B accordingly. In this case, the IoT device B may be unable to operate normally (or even damaged) due to incorrect firmware update.

### SUMMARY

The invention is directed to a network device, which is adapted to solve the above technical problem.

The invention provides a network device including a communication circuit and a processor. The communication circuit is coupled to an update server. The processor is coupled to the communication circuit and configured to execute: in response to determining that a version of a first update file from the update server satisfies a predetermined condition, controlling the communication circuit to obtain the first update file from the update server; reading identification information from at least one predetermined data location of the first update file; in response to determining that the identification information in the first update file matches the network device, updating the network device based on the first update file.

Based on the above, the network device of the invention may avoid malfunctions caused by updating based on incorrect update files.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a network device according to an embodiment of the invention.

FIG. 2 is a flowchart of a firmware update method according to an embodiment of the invention.

FIG. 3A is a schematic diagram of a first update file according to an embodiment of the invention.

FIG. 3B is a schematic diagram of a first update file according to another embodiment of the invention.

### DESCRIPTION OF THE EMBODIMENTS

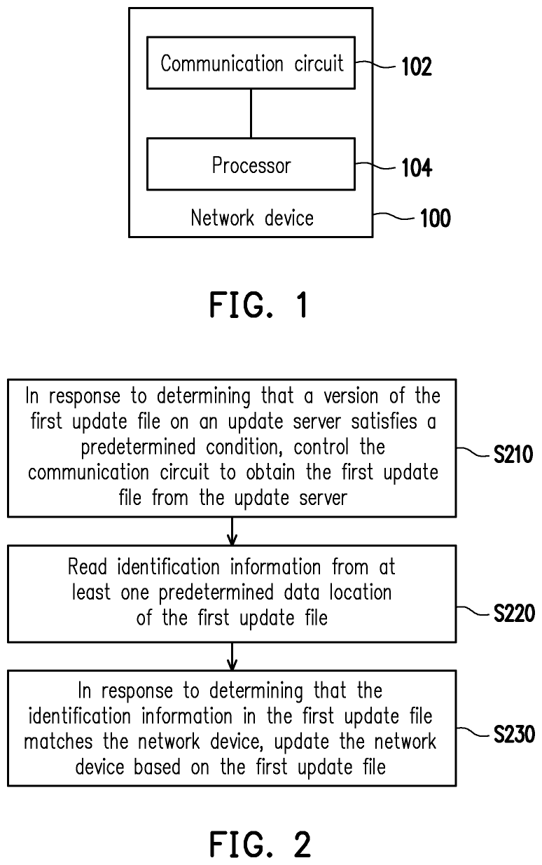

Referring to FIG. 1, FIG. 1 is a schematic diagram of a network device according to an embodiment of the invention. In different embodiments, a network device 100 may be implemented as various smart devices and/or computer devices with network communication functions, but the invention is not limited thereto. In some embodiments, the network device 100 may also be implemented as various Internet of Things devices with network communication functions.

In FIG. 1, the network device 100 includes a communication circuit 102 and a processor 104. The communication circuit 102 may be a communication protocol module, which may support a global system for mobile communication (GSM) system, a code division multiple access (CDMA) system, a wireless fidelity (Wi-Fi) system, signal transmission of worldwide interoperability for microwave access (WiMAX), long term evolution (LTE) and/or new radio (New radio, NR).

The communication circuit 102 is communicatively coupled to an update server, and may include at least a transmitter circuit, a receiver circuit, an analog-to-digital (A/D) converter, a digital-to-analog (D/A) converter, a low noise amplifier (LNA), a mixer, a filter, a matching circuit, a transmission line, a power amplifier (PA), one or more antennas units and a local storage medium, but the invention is not limited thereto, which used to provide a network communication function for the network device 100 of FIG. 1.

The processor 104 is coupled to the communication circuit 102, and may be a general purpose processor, a special purpose processor, a conventional processor, a digital signal processor, a plurality of microprocessors, one or more microprocessors combined with a digital signal processor core, a controller, a microcontroller, an application specific integrated circuit (ASIC), a field programmable gate array (FPGA), any other type of integrated circuit, a state machine, an advanced RISC machine (ARM)-based processor, and similar products.

In the embodiment of the invention, the processor 104 may access specific modules and program codes to implement a firmware update method provided by the invention, and details thereof are described below.

Referring to FIG. 2, FIG. 2 is a flowchart of a firmware update method according to an embodiment of the invention. The method of the embodiment may be executed by the network device 100 in FIG. 1, and details of each step in FIG. 2 are described below with reference to the components shown in FIG. 1.

In an embodiment of the invention, relevant maintenance personnel may upload a first update file F1 (which may be used, for example, to update a firmware of a certain network device) to the update server. In an embodiment, the processor 104 may determine whether a version of the first update file F1 on the update server satisfies a predetermined condition.

In an embodiment, in response to determining that the version of the first update file F1 is newer than a current version of the network device 100 (for example, a current firmware version of the network device 100), the processor 104 may determine that the version of the first update file F1 satisfies the predetermined condition. On the other hand, in response to determining that the version of the first update file F1 is older than or equal to the current version of the network device 100, the processor 104 may determine that the version of the first update file F1 does not satisfy the predetermined condition, but the invention is not limited thereto.

Based on the above, in step S210, in response to determining that the version of the first update file F1 on the update server satisfies the predetermined condition, the processor 104 controls the communication circuit 102 to obtain (for example, download) the first update file F1 from the update server.

In the embodiment of the invention, the first update file F1 uploaded to the update server by the maintenance personnel does not necessarily correspond to the network device 100, but may correspond to network devices belonging to other device types. In this case, if the processor 104 determines that the first update file F1 satisfies the above predetermined condition, the processor 104 may still control the communication circuit 102 to download the first update file F1 from the update server. Namely, the network device 100 may download the first update file F1 from the update server without confirming whether the first update file F1 may be used to update the target device. Therefore, the first update file F1 obtained by the network device 100 may not be related to the network device 100, but the invention is not limited thereto.

Then, in step S220, the processor 104 reads identification information (referred to as I1 hereinafter) from at least one predetermined data location of the first update file F1.

In the embodiment of the invention, the at least one predetermined data location is, for example, one or more data locations used to store the identification information I1 in the first update file F1.

In a first embodiment, in response to determining that the version of the first update file F1 on the update server satisfies the predetermined condition, the processor 104 may obtain an indication signal from the update server during a handshake process with the update server, where the indication signal may include the one or more predetermined data locations. Namely, the update server may notify the network device 100 of one or more predetermined data locations for storing the identification information in the first update file F1 through the instruction signal. In this way, the processor 104 may attempt to read the identification indication I1 from one or more predetermined data locations of the first update file F1 based on the information provided by the indication signal, but the invention is not limited thereto.

In a second embodiment, the at least one predetermined data location is, for example, one or more fixed data locations used to store the identification information I1 in the first update file F1. Namely, when the relevant personnel edit the first update file F1 (or other update files corresponding to the network device 100), the identification information I1 may be fixedly written to the at least one predetermined data location for the network device 100 to read the identification information I1 after obtaining the first update file F1, but the invention is not limited thereto.

In an embodiment, the first update file F1 is, for example, a BIN file, and each predetermined data location may be at least 1 KB away from a beginning data location of the BIN file.

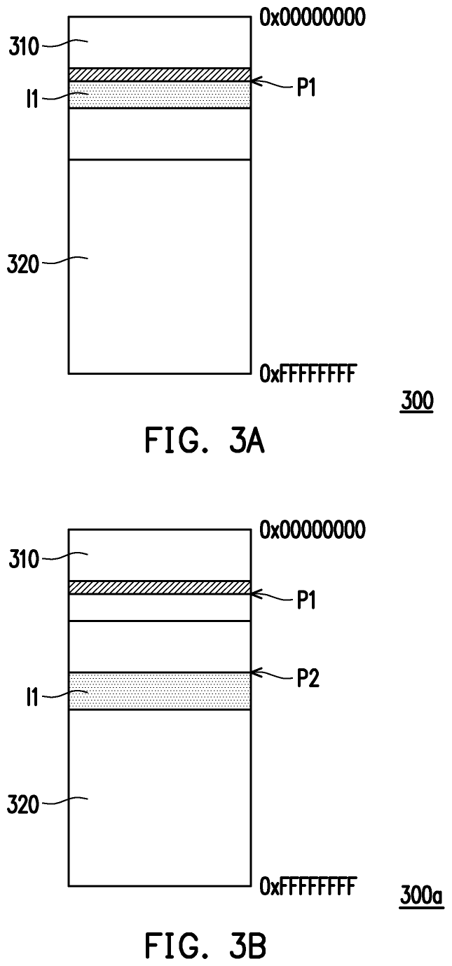

Referring to FIG. 3A, FIG. 3A is a schematic diagram of a first update file according to an embodiment of the invention. In FIG. 3A, the first update file F1 is, for example, a BIN file 300, which may include an interrupt service routine (ISR) data string 310, identification information I1, and update content 320, where the update content 320 may be used, for example, to update the firmware of the network device 100, but the invention is not limited thereto.

In the embodiment, the beginning data location of the BIN file 300 is, for example, 0x00000000, and the predetermined data location P1 used to store the identification information I1 may be at least 1 KB away from this beginning data location.

Specifically, since a size of the general ISR data string 310 is mostly less than 1 KB, if the predetermined data location P1 is at least 1 KB away from the beginning data location of the BIN file 300, overwriting of the identification information I1 to the ISR data string 310 may be avoided, and a size of an empty data segment (such as the slashed area in FIG. 3) may be reduced at the same time.

In an embodiment, the predetermined data location P1 may also be designed to be located immediately after the ISR data string 310 (i.e., there is no empty data string between the predetermined data location P1 and the ISR data string 310), but the invention is not limited thereto.

In other embodiments, the first update file F1 may include a plurality of predetermined data locations, and the network device 100 may try to read the identification information I1 from these predetermined data locations until the identification information I1 is obtained.

Referring to FIG. 3B, FIG. 3B is a schematic diagram of a first update file according to another embodiment of the invention. In FIG. 3B, the first update file F1 is, for example, a BIN file 300a, which may be designed with predetermined data locations P1 and P2, and the identification information I1 may be stored at the predetermined data location P2. In the embodiment, after the processor 104 obtains the BIN file 300a, it may attempt to read the identification information I1 from the predetermined data location P1. In the embodiment, since the identification information I1 is stored in the default data location P2, the processor 104 cannot successfully read the identification information I1 from the predetermined data location P1.

Thereafter, the processor 104 may try to again read the identification information I1 from the predetermined data location P2, and may successfully read the identification information I1 from the predetermined data location P2, but the invention is not limited thereto.

In other embodiments, the considered BIN file under may be designed to have more predetermined data locations, and the identification information I1 may be designed to be stored in one or more of these predetermined data locations for the processor 104 to read, but the invention is not limited thereto.

In other embodiments, if the processor 104 cannot read the identification information from one or more predetermined data locations in the obtained first update file F1, it represents that the first update file F1 may not be used to update the network device 100. In this case, the processor 104 may not update the network device 100 based on the first update file F1.

In an embodiment, after the processor 104 obtains the identification information I1 from the first update file F1, the processor 104 may determine whether the identification information I1 matches the network device 100. In an embodiment, the content of the identification information I1 may be designed to correspond to a device name, a serial number, a unique identification code or a combination thereof of the network device 100, but the invention is not limited thereto.

For example, it is assumed that the device name of the network device 100 is “device123”, the identification information I1 may also be designed to be “device123” accordingly. In this way, the processor 104 may learn that the first update file F1 is used to update the network device 100 by determining that the identification information I1 matches the device name of the network device 100.

Based on the above, in step S230, in response to determining that the identification information I1 in the first update file F1 matches the network device 100, the processor 104 updates the network device 100 based on the first update file F1. In an embodiment, the processor 104 may, for example, update the firmware of the network device 100 based on the first update file F1, but the invention is not limited thereto.

In other embodiments, if the identification information I1 read by the processor 104 from the obtained first update file F1 does not match the network device 100, it means that the first update file F1 is not used to update the network device 100. Therefore, the processor 104 may continue to monitor the update server (and/or does not update the network device 100 based on the first update file F1).

In this way, it is ensured that the network device 100 may be updated based on a correct update file, thereby avoiding malfunctions caused by updating based on an incorrect update file.

In an embodiment, if the identification information I1 is stored in the BIN file in an easily readable form (such as the above-mentioned “device123”), an intentional person (such as a hacker) may probably modify the updated content in the BIN file after learning the location of the identification information I1 in the BIN file. In this case, after the network device 100 is updated according to the BIN file, it may become a puppet device controlled by the hacker and may be used for mining and/or network attacks.

Therefore, in an embodiment, the identification information I1 may be designed as an encrypted data string (such as a hashed data string), and this data string may be identified by the network device 100, i.e., this data string is a known data string to the network device 100. In this case, even if the hacker obtains the BIN file, the hacker is difficult to decipher the identification information I1 therein, and is unable to successfully know which kind of network device the BIN file is used to update, and is difficult to convert the corresponding network device into the above-mentioned puppet device.

For the network device 100, since the above-mentioned encrypted data string is known, the network device 100 may determine whether the identification information I1 matches the data string after obtaining the identification information I1 from the BIN file, so as to learn whether the obtained BIN file is used to update the network device 100.

In an embodiment, if the relevant personnel upload a new update file (referred to as a second update file F2 hereinafter) to the update server, the processor 104 may still determine whether to update the network device 100 based on the previously taught mechanism.

For example, in response to determining that the second update file F2 appears on the update server, and that a version of the second update file F2 is newer than the version of the first update file F1 (which may be understood as a current firmware version of the network device 100), the processor 104 may control the communication circuit 102 to obtain (for example, download) the second update file F2 from the update server. Thereafter, the processor 104 may read the identification information (referred to as I2 hereinafter) from one or more predetermined data locations of the second update file F2, where the one or more predetermined data locations of the second update file F2 may respectively correspond to the one or more predetermined data locations of the first update file F1. Then, in response to determining that the identification information I2 in the second update file F2 matches the network device 100, the processor 104 may update the network device 100 based on the second update file F2.

In brief, when the second update file F2 appears on the update server, the processor 104 may download the second update file F2 from the update server when determining that the second update file F2 satisfies the predetermined condition. Thereafter, the processor 104 may try to read the identification information I2 from one or more predetermined data locations of the second update file F2, and update the network device 100 based on the second update file F2 when the identification information I2 matches the network device 100. Related details may be deduced with reference of the descriptions of the previous embodiments, which will not be repeated.

In summary, the network device of the invention may obtain the identification information from the predetermined data location of the update file after obtaining the update file satisfying the predetermined condition from the update server, and when the identification information matches the network device, (the firmware of) the network device is updated based on the update file. In this way, it is ensured that the network device may be updated based on the correct update file, thereby avoiding malfunctions of the network device caused by updating based on an incorrect update file.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A network device, comprising:
a communication circuit, coupled to an update server; and
a processor, coupled to the communication circuit and configured to execute:
in response to determining a version of a first update file from the update server satisfies a predetermined condition, controlling the communication circuit to obtain the first update file from the update server;
reading identification information from at least one predetermined data location of the first update file; and
in response to determining the identification information in the first update file matches the network device, updating the network device based on the first update file.

2. The network device as claimed in claim 1, wherein the processor executes:
in response to determining the version of the first update file is newer than a current version of the network device, determining the version of the first update file satisfies the predetermined condition; and
in response to determining the version of the first update file is older than or equal to the current version of the network device, determining the version of the first update file does not satisfy the predetermined condition.

3. The network device as claimed in claim 1, wherein the processor executes:
in response to determining the version of the first update file from the update server satisfies the predetermined condition, obtaining an indication signal from the update server during a handshake process with the update server, wherein the indication signal comprises the at least one predetermined data location.

4. The network device as claimed in claim 1, wherein the first update file is a BIN file, and each of the at least one predetermined data location is at least 1 KB away from a beginning data location of the BIN file.

5. The network device as claimed in claim 1, wherein the first update file is a BIN file, the BIN file comprises an interrupt service routine data string, and the at least one predetermined data location is located immediately after the interrupt service routine data string.

6. The network device as claimed in claim 1, wherein the processor executes:
in response to determining the identification information does not match the network device, continuing monitoring the update server.

7. The network device as claimed in claim 1, wherein the identification information is an encrypted data string, and the network device is able to identify the encrypted data string.

8. The network device as claimed in claim 1, wherein the at least one predetermined data location at least comprises a first predetermined data location and a second predetermined data location in the first update file, and the processor executes:
attempting to read the identification information at the first predetermined data location;
in response to determining the identification information is not successfully read from the first predetermined data location, attempting to read the identification information from the second predetermined data location.

9. The network device as claimed in claim 1, wherein the first update file is configured to update a firmware of the network device.

10. The network device as claimed in claim 1, wherein the processor further executes:
in response to determining a second update file appears on the update server and a version of the second update file is newer than the version of the first update file, controlling the communication circuit to obtain the second update file from the update server;
reading the identification information from at least one predetermined data location of the second update file, wherein the at least one predetermined data location of the second update file respectively corresponds to the at least one predetermined data location of the first update file; and
in response to determining the identification information in the second update file matches the network device, updating the network device based on the second update file.
